(19) United States
(12) Patent Application Publication
(10) Pub. No.: US 2024/0054441 A1
(43) Pub. Date: Feb. 15, 2024

(54) OPTIMIZATION APPARATUS, OPTIMIZATION METHOD, AND NON-TRANSITORY COMPUTER-READABLE MEDIUM

(71) Applicant: NEC Corporation, Minato-ku, Tokyo (JP)

(72) Inventors: Akio TODA, Tokyo (JP); Hiroshi CHISHIMA, Tokyo (JP); Kenji TSUKIYAMA, Tokyo (JP)

(73) Assignee: NEC Corporation, Koto-ku, Tokyo (JP)

(21) Appl. No.: 18/270,822

(22) PCT Filed: Dec. 6, 2021
(86) PCT No.: PCT/JP2021/044723

§ 371 Date: Jul. 3, 2023

(30) Foreign Application Priority Data
Jan. 12, 2021 (JP) 2021-002925

(51) Int. Cl. G06Q 10/0835; G06Q 10/047; G06Q 50/28

(52) U.S. Cl. CPC G06Q 10/08355; G06Q 10/047; G06Q 50/28

(57) ABSTRACT

There is provided an optimization apparatus that reduces the time required to create a delivery plan. An optimization apparatus (100) includes an acquisition unit (110) that acquires delivery information regarding each of one or more products for each of a plurality of consumption locations, an identification unit (120) that identifies a plurality of delivery task candidates departing from a delivery source, delivering the one or more products to each of one or more consumption locations, and returning to the delivery source, a determination unit (130) that determines, based on the delivery information, at least one of evaluation values and a vehicle type of a delivery vehicle for each candidate, and a selection unit (140) that selects a plurality of delivery tasks from the plurality of identified candidates based on a result of optimizing an objective function based on a determination result.

### TECHNICAL FIELD

The present invention relates to an optimization apparatus, an optimization method, and an optimization program.

### BACKGROUND ART

Patent Literature 1 discloses a technique for creating a delivery plan by maximizing or minimizing an objective function from a combination of a large number of factors, such as delivery destinations, delivery varieties, and delivery timeframes. For optimization, meta-heuristics, such as local search, a genetic algorithm, and annealing, are used.

### CITATION LIST

### Patent Literature

Patent Literature 1: Japanese Unexamined Patent Application Publication No. 2005-096928

### SUMMARY OF INVENTION

### Technical Problem

According to the technique disclosed in Patent Literature 1, as the number of delivery destinations increases, the number of combinations becomes enormous and the scale of the problem often increases, which causes a problem that calculating a valid solution in a realistic amount of time is difficult.

The present disclosure has been made to solve such a problem and provides an optimization apparatus, an optimization method, and an optimization program that reduce the time required to create a delivery plan.

### Solution to Problem

An optimization apparatus according to the present disclosure includes:
an acquisition unit that acquires delivery information regarding each of one or more products for each of a plurality of consumption locations;
an identification unit that identifies a plurality of delivery task candidates departing from a delivery source, delivering the one or more products to each of one or more consumption locations, and returning to the delivery source;
a determination unit that determines, based on the delivery information, at least one of evaluation values and a vehicle type of a delivery vehicle for each candidate; and
a selection unit that selects a plurality of delivery tasks from the plurality of identified candidates based on a result of optimizing an objective function based on a determination result.

An optimization method according to the present disclosure includes:
acquiring, by a computer, delivery information regarding each of one or more products for each of a plurality of consumption locations;
identifying, by the computer, a plurality of delivery task candidates departing from a delivery source, delivering the one or more products to each of one or more consumption locations, and returning to the delivery source;
determining, by the computer, at least one of evaluation values and a vehicle type of a delivery vehicle for each candidate based on the delivery information; and
selecting, by the computer, a plurality of delivery tasks from the plurality of identified candidates based on a result of optimizing an objective function based on a determination result.

An optimization program according to the present disclosure causes a computer to execute:
acquiring delivery information regarding each of one or more products for each of a plurality of consumption locations;
identifying a plurality of delivery task candidates departing from a delivery source, delivering the one or more products to each of one or more consumption locations, and returning to the delivery source;
determining at least one of evaluation values and a vehicle type of a delivery vehicle for each candidate based on the delivery information; and
selecting a plurality of delivery tasks from the plurality of identified candidates based on a result of optimizing an objective function based on a determination result.

### Advantageous Effects of Invention

With an optimization apparatus, an optimization method, and an optimization program according to the present disclosure, it is possible to reduce the time required to create a delivery plan.

### BRIEF DESCRIPTION OF DRAWINGS

FIG. 1 is a block diagram showing a configuration of an optimization apparatus according to a first example embodiment;

FIG. 2 is a configuration diagram showing an example of a hardware configuration of the optimization apparatus according to the first example embodiment;

FIG. 3 is a block diagram showing a configuration of an optimization apparatus according to a second example embodiment;

FIG. 4 is a schematic diagram showing specific examples of delivery information;

FIG. 5 is a schematic diagram showing information contained in a delivery block;

FIG. 6 is a schematic diagram showing an example of a delivery block for an operation for delivery to one consumption location;

FIG. 7 is a schematic diagram showing an example of a delivery block for an operation for delivery to two consumption locations;

FIG. 8 is a flowchart showing a procedure of an optimization method according to the second example embodiment; and

FIG. 9 is a schematic diagram for explaining a method for identifying a delivery task candidate.

### EXAMPLE EMBODIMENT

### First Example Embodiment

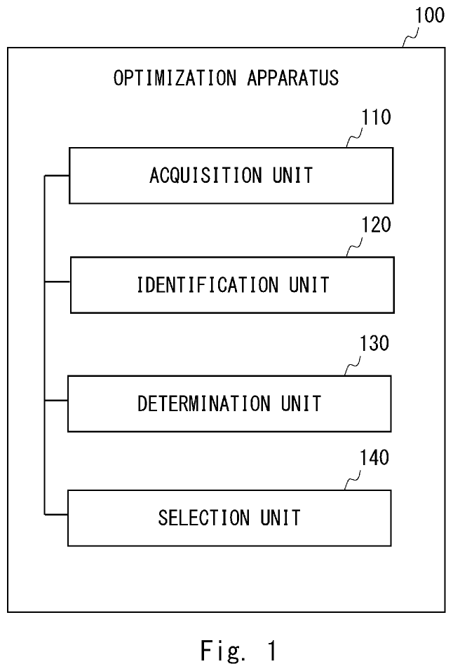

Hereinafter, example embodiments of the present invention will be described with reference to the drawings. FIG. 1 is a configuration diagram showing a configuration of an optimization apparatus 100 according to a first example embodiment. The optimization apparatus 100 includes an acquisition unit 110, an identification unit 120, a determination unit 130, and a selection unit 140.

The acquisition unit 110 acquires delivery information regarding each of one or more products for each of a plurality of consumption locations. The delivery information may be information specifying a delivery timeframe and delivery quantity or information specifying delivery quantity for each timeframe. The acquisition unit 110 may acquire the delivery information based on order information, for example. If a delivery timeframe and delivery quantity are not specified by a delivery destination, the acquisition unit 110 may acquire the delivery information by determining delivery quantity for each timeframe based on the estimated consumption rate of a product.

The identification unit 120 determines a plurality of delivery task candidates departing from a delivery source, delivering one or more products to each of one or more consumption locations, and returning to the delivery source. The identification unit 120 may identify, as candidates, delivery tasks for delivery to a plurality of consumption locations where the mutual distances are less than or equal to a threshold, for example. In addition, the identification unit 120 may identify, as candidates, delivery tasks for delivery to one consumption location and delivery tasks for delivery to two consumption locations.

The plurality of candidates may include not only different trips, but also the same trip with different delivery companies. Here, a trip is defined as a travel that departs from a delivery source, delivers one or more products to each of one or more consumption locations, and returns to the delivery source. If delivery companies are different, the delivery costs or the like can be different for the same trip. Note that the identification unit 120 may identify candidates for the delivery tasks based on the delivery information acquired by the acquisition unit 110. The identification unit 120 may identify a trip in which the delivery quantity is less than or equal to a predetermined value as a candidate for the delivery task. This allows the identification unit 120 to identify, as candidates, those that do not exceed the maximum loading capacity of a delivery vehicle.

The determination unit 130 determines, based on the delivery information acquired by the acquisition unit 110, at least one of evaluation values in each candidate identified by the identification unit 120 and a vehicle type of a delivery vehicle. The evaluation value is, for example, quantity of transportation per travel distance (delivery efficiency), a delivery cost, a travel distance, or the like. The identification unit 120 may calculate a plurality of evaluation values. The vehicle type is, for example, large, medium, small, or the like. According to the determination result, the optimization apparatus 100 may register, for each candidate, delivery data (also referred to as a delivery block) including a consumption location for delivery (delivery destination), the delivery quantity of each of one or more products for each delivery destination, the evaluation values, and the vehicle type in a storage device (not shown).

The selection unit 140 selects, based on a result of optimizing an objective function based on the determination result of the determination unit 130, a plurality of delivery tasks from the plurality of candidates identified by the identification unit 120. The objective function may be optimized with satisfying a constraint on the number of times of delivery for each consumption location based on the delivery information, for example. Alternatively, the objective function may be optimized with satisfying a constraint on the number of vehicle types. The objective function may include, for example, the evaluation values of candidates. The objective function may be optimized by annealing or other meta-heuristics. Note that the optimization calculation may be performed inside the optimization apparatus 100 or outside the optimization apparatus 100.

The optimization apparatus according to the first example embodiment identifies a plurality of delivery task candidates and selects the optimal delivery task combination from the plurality of candidates. With the optimization apparatus according to the first example embodiment, no optimization calculation is performed when delivery task candidates are identified, which reduces the calculation amount in optimization calculation, and a delivery plan can be created in a short time.

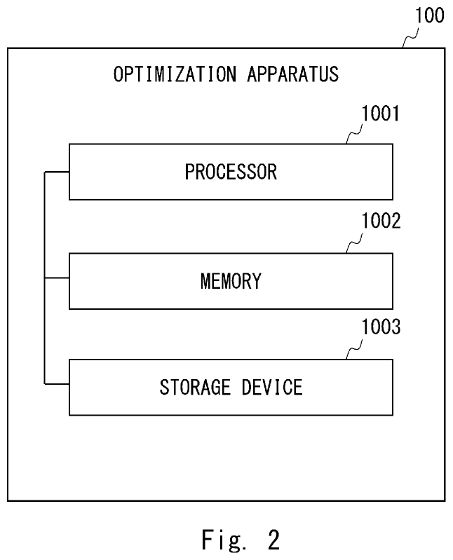

FIG. 2 is a diagram showing an example of the hardware configuration of the optimization apparatus 100. The optimization apparatus 100 includes a processor 1001, a memory 1002, and a storage device 1003. The storage device 1003 stores a computer program implementing the processing of an optimization method according to the first example embodiment. The processor 1001 loads the computer program from the storage device 1003 into the memory 1002 to execute the computer program. This allows the processor 1001 to implement the functions of the acquisition unit 110, the identification unit 120, the determination unit 130, and the selection unit 140.

Alternatively, the acquisition unit 110, the identification unit 120, the determination unit 130, and the selection unit 140 may be implemented by dedicated hardware. In addition, a part or all of the constituent elements of each device may be implemented by a general-purpose or dedicated circuitry, a processor, or the like or a combination thereof. These may be configured by a single chip or a plurality of chips connected via a bus. A part or all of the constituent elements of each device may be implemented by a combination of the circuitry or the like described above and a program. In addition, as a processor, a central processing unit (CPU), a graphics processing unit (GPU), a field-programmable gate array (FPGA) or the like can be used. The optimization apparatus 100 may include a quantum chip (not illustrated) that performs quantum annealing.

If a part or all of the constituent elements of the optimization apparatus 100 are implemented by a plurality of information processing devices, circuitries, or the like, the plurality of information processing devices, circuitries, or the like may be collectively or dispersedly arranged. For example, the information processing devices, circuitries, or the like may be implemented by being connected with each other via a communication network, such as a client server system or a cloud computing system. In addition, the function of the optimization apparatus 100 may be provided in a form of Software as a Service (SaaS).

### Second Example Embodiment

A second example embodiment is a specific example of the first example embodiment. In the following, descriptions that overlap with those in the first example embodiment are omitted. An optimization apparatus 100a according to the second example embodiment optimizes a plan for delivering a product to a plurality of consumption locations. The optimization apparatus 100a optimizes, for example, a plan for delivering petroleum or liquefied natural gas by tanker truck. The petroleum is, for example, gasoline, kerosene, light oil, heavy oil, or the like. There may be a plurality of product types. The product types are, for example, regular gasoline and high-octane gasoline.

The consumption locations are, for example, gas stations and other customers. The consumption locations are also referred to as service stations (SS). The consumption locations include a first kind of consumption location and a second kind of consumption location. For the first kind of consumption location, a timeframe for delivery and the quantity of a product to be delivered are specified by a customer. The first kind of consumption location is also referred to as a consumption location for a specified order. For the second kind of consumption location, a timeframe for delivery and the quantity of a product to be delivered are not specified, but delivery must be made so as not to run out of stock. The second kind of consumption location is also referred to as a consumption location for a contract order.

As described in detail later, for the first kind of consumption location, the delivery timeframe and delivery quantity are determined based on order information. For the second kind of consumption location, the delivery quantity for each timeframe when delivery is to be made is determined based on consumption forecast information.

A travel that departs from a delivery source, delivers to each of one or more consumption locations, and returns to the delivery source is referred to as a trip, as described above. If the delivered product is gasoline, the delivery source may be an oil terminal. If a plurality of oil terminals are in the delivery area, the delivery source may be different from a delivery source to which a delivery vehicle returns after delivery to the consumption locations.

As described later, the optimization apparatus 100a creates a plurality of delivery task candidates and selects the optimal combination from the plurality of candidates to create a delivery plan. As described later, delivery data including a consumption location for delivery (delivery destination), delivery quantity, an evaluation value of delivery efficiency or the like, and the vehicle type of a delivery vehicle is generated for each candidate. Such delivery data is referred to as a delivery block. The optimization apparatus 100a generates a plurality of such delivery blocks and selects (extracts) the delivery blocks corresponding to operations that actually deliver the products to create a delivery plan.

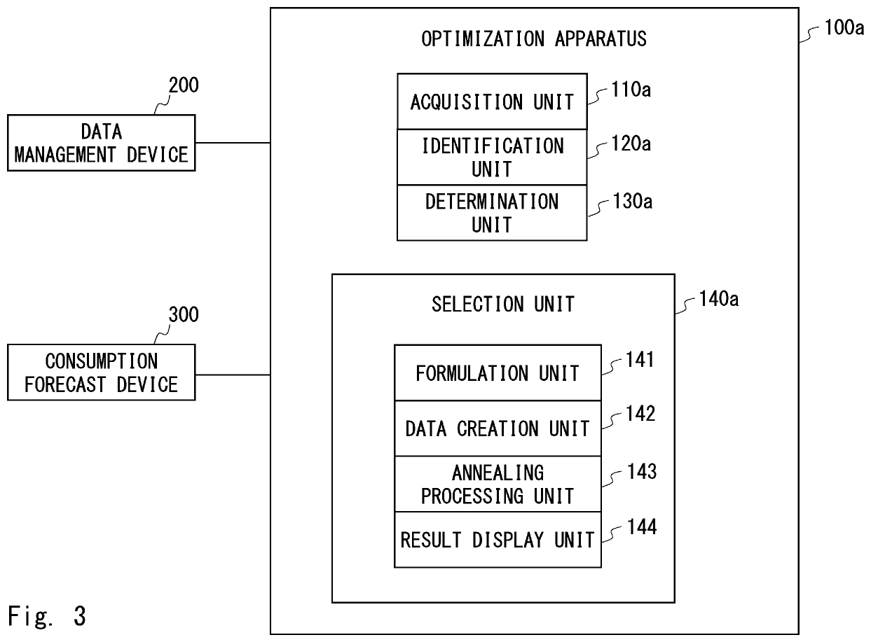

FIG. 3 is a configuration diagram showing the configuration of the optimization apparatus 100a. The optimization apparatus 100a is connected to a data management device 200 that stores order information and a consumption forecast device 300 that forecasts the consumption of a product to be delivered. The optimization apparatus 100a includes an acquisition unit 110a, an identification unit 120a, a determination unit 130a, and a selection unit 140a. The acquisition unit 110a is an example of the acquisition unit 110 described above. The acquisition unit 110a acquires order information regarding the first kind of consumption location from the data management device 200. Then, the acquisition unit 110a determines the timeframe for delivery and the delivery quantity based on the order information to acquire delivery information. The acquisition unit 110a further acquires consumption forecast information regarding the second kind of consumption location from the consumption forecast device 300. Then, the acquisition unit 110a determines, for each timeframe, the delivery quantity when delivery is to be made based on the forecast information to acquire the determined result as delivery information. The acquisition unit 110a may also determine the delivery quantity by taking into account the stock quantity at each consumption location.

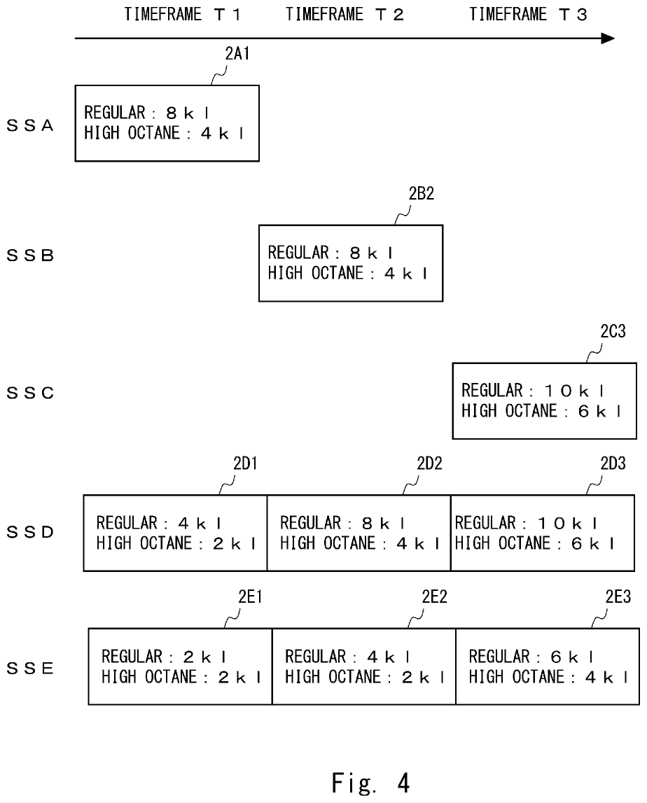

With reference to FIG. 4, the delivery information is described. The acquisition unit 110a acquires the delivery information regarding each of consumption locations SSA, SSB, SSC, SSD, and SSE. The consumption locations SSA, SSB, and SSC are the first kind of consumption locations. The consumption locations SSD and SSE are the second kind of consumption locations.

The acquisition unit 110a acquires delivery information 2A1 regarding the consumption location SSA, delivery information 2B2 regarding the consumption location SSB, and delivery information 2C3 regarding the consumption location SSC. The acquisition unit 110a further acquires delivery information 2D1 to 2D3 regarding the consumption location SSD and delivery information 2E1 to 2E3 regarding the consumption location SSE. A horizontal position in each delivery information indicates a timeframe in which delivery is to be made, and a rightward position means a later timeframe. Timeframes T1, T2, and T3 may correspond to morning, afternoon, and night, respectively, as described above. The delivery information 2A1 to 2E3 is also referred to as a delivery plan.

For the first kind of consumption locations SSA, SSB, and SSC, the delivery quantity in any of the timeframes T1 to T3 has been determined. For example, referring to the delivery information 2A1 regarding SSA, it has been determined that 8 kl of regular gasoline and 4 kl of high-octane gasoline are to be delivered in the timeframe T1.

For the second kind of consumption locations SSD and SSE, the delivery quantity for each timeframe when delivery is to be made has been determined. For example, referring to the delivery Information 2D1 to 2D3 regarding SSD, it has been determined that 4 kl of regular gasoline and 2 kl of high-octane gasoline are to be delivered in the timeframe T1, that 8 kl of regular gasoline and 4 kl of high-octane gasoline are to be delivered in the timeframe T2, and that 10 kl of regular gasoline and 6 kl of high-octane gasoline are to be delivered in the timeframe T3. Here, as described above, the delivery quantity (for example, oil volume) for each timeframe is calculated based on the consumption forecast. Since the consumption in the earlier timeframes is taken into account, the delivery quantity is increased as the timeframe gets later.

Returning to FIG. 3, the identification unit 120a is an example of the identification unit 120 described above. The identification unit 120a identifies, based on the delivery information acquired by the acquisition unit 110a, a plurality of delivery task candidates in which the delivery quantities do not exceed the upper limits. Note that the identification unit 120a may determine the candidates for the delivery tasks by taking into account conditions other than the delivery quantity. It can be said that the identification unit 120a identifies delivery tasks that are feasible to actually make delivery.

An example of a method for creating the delivery task candidates is described below. For example, the identification unit 120a first identifies delivery tasks for delivery to one consumption location, and then identifies delivery tasks for delivery to two consumption locations. Here, for the delivery tasks for delivery to two consumption locations, a task in which the delivery quantity does not exceed a predefined upper limit (for example, the upper limit of the loading capacity of a delivery vehicle) is identified as a candidate. In other words, the identification unit 120a determines whether the delivery quantity of the product is less than or equal to a threshold, and identifies the delivery task as the second kind of candidate when the determination result is true.

Note that, when identifying a delivery task for delivery to two consumption locations, the identification unit 120a may identify a delivery task for delivery to two consumption locations whose distance from each other is less than or equal to a threshold. Needless to say, the identification unit 120a may identify a candidate for a delivery task for delivery to three or more consumption locations. A delivery task for delivery to a plurality of consumption locations whose distances from each other are equal to or less than the threshold is considered to be an appropriate candidate in terms of delivery efficiency and the like. In addition, including a delivery task for delivery to one consumption location in candidates ensures that all consumption locations are included in the delivery destinations of the candidates.

Those satisfy the following various conditions may be identified as candidates. First, each candidate may be identified by taking into account the upper and lower storage level limits of the tank installed at each SS. In addition, each candidate may be identified by taking into account the timeframe set for each SS in which delivery can be made. Each candidate may be identified by taking into account the time required for delivery (delivery time). Each candidate may be identified by taking into account the type of a vehicle that can be used for delivery at each SS. Here, each candidate may be identified by taking into account the work time (refueling time) at the delivery source or SS. Note that the delivery quantity is not changed for a specified order.

The determination unit 130a is an example of the determination unit 130 described above. For each candidate identified by the identification unit 120a, the determination unit 130a calculates evaluation values such as delivery efficiency based on the delivery information and also determines the vehicle type of a delivery vehicle based on the delivery information. Then, the determination unit 130a generates delivery data including the delivery destination (consumption location), the delivery quantity, the evaluation values, the vehicle type, and the like in each candidate, and registers the delivery data in a storage device (not shown). Such delivery data is also referred to as a delivery block.

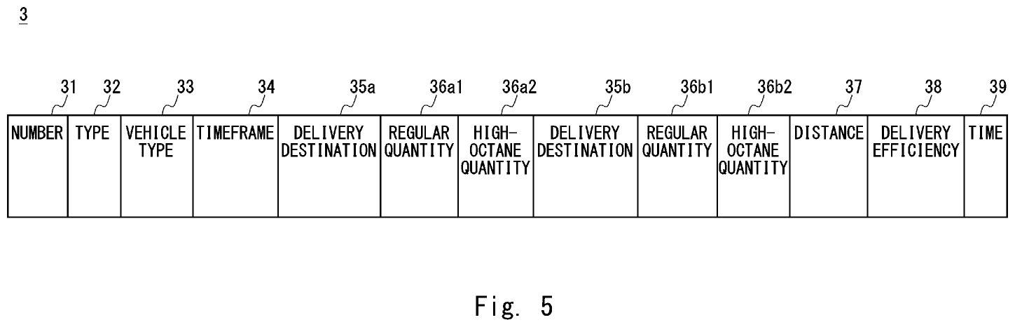

With reference to FIG. 5, a delivery block 3 is described. The delivery block 3 includes a number 31, a type 32, a vehicle type 33, a timeframe 34, a delivery destination 35a, regular quantity 36a1, high-octane quantity 36a2, a delivery destination 35b, regular quantity 36b1, high-octane quantity 36b2, a distance 37, delivery efficiency 38, and a time 39. Note that FIG. 5 is an example, and the delivery block 3 may contain three or more delivery destinations.

The number 31 is the identification number of each delivery block. The type 32 is information indicating the number of delivery destinations. The type 32 may be considered as indicating the type of trip; whether the trip for delivering to one consumption location and returning to the delivery source or a trip for delivering two consumption locations and returning to the delivery source.

The vehicle type 33 is the type of a delivery vehicle and is, for example, large, medium, or small. Depending on the vehicle type 33, the loading capacity of the delivery vehicle differs. The determination unit 130a may determine the vehicle type 33 based on, for example, the result of adding the regular quantity 36a1, the regular quantity 36b1, the high-octane quantity 36a2, and the high-octane quantity 36b2, which will be described later. Note that the determination unit 130a may calculate the total delivery quantity for each type of a product to be delivered to determine the vehicle type 33. The vehicle type 33 may be determined, for example, to be small when the total delivery quantity is less than or equal to 12 kl, medium when the delivery quantity exceeds 12 kl and is less than or equal to 18 kl, and large when the delivery quantity exceeds 18 kl and is less than or equal to 24 kl. The timeframe 34 indicates the timeframes T1 to T3 in which delivery is to be made.

The delivery destination 35a is information indicating the consumption location where the delivery is to be made first. For a candidate for a delivery task for delivery to one consumption location, information indicating the consumption location may be registered in the delivery destination 35a, and no information may be registered in the delivery destination 35b. The regular quantity 36a1 is the delivery quantity of regular gasoline to be delivered to the delivery destination 35a and is expressed in kl or the like. The high-octane quantity 36a2 is the delivery quantity of high-octane gasoline to be delivered to the delivery destination 35a and is expressed in kl or the like.

The delivery destination 35b is information indicating the consumption location where the delivery is to be made second. As described above, when delivery is made to one consumption location, no information may be registered. The regular quantity 36b1 indicates the delivery quantity of regular gasoline to be delivered to the delivery destination 35b, and the high-octane quantity 36b2 indicates the delivery quantity of high-octane gasoline to be delivered to the delivery destination 35b. Note that when a candidate for a delivery task for delivery to three or more locations is identified, the delivery block 3 may contain three or more delivery destinations.

The distance 37 is a travel distance in the delivery task and is expressed in km or the like. In a case of delivery to one consumption location, the distance 37 is the distance from the delivery source to the delivery destination 35a and from the delivery destination 35a to the delivery source. In the case of delivery to two consumption locations, the distance 37 is the distance from the delivery source to the delivery destination 35a, from the delivery destination 35a to the delivery destination 35b, and from the delivery destination 35b to the delivery source. The determination unit 130a may calculate the distance 37 based on, for example, map information or the like.

The delivery efficiency 38 indicates the delivery quantity per travel distance and is in units of, for example, [kl/km]. The determination unit 130a may determine the delivery efficiency 38 by, for example, adding the regular quantity 36a1, the high-octane quantity 36a2, the regular quantity 36b1, and the high-octane quantity 36b2 to calculate the total delivery quantity and dividing the total by the distance 37.

The time 39 is the time required for the delivery task. The time 39 is calculated using, for example, the distance 37 and a predetermined vehicle speed (for example, 50 km/h). The predetermined vehicle speed may be determined depending on the vehicle type 33. In addition, the time 39 may take into account the time for unloading the delivery product at the delivery destinations 35a and 35b.

The delivery block 3 may contain a delivery cost instead of the delivery efficiency 38. The delivery cost is, for example, the amount to be paid to a delivery company and may be calculated based on the distance 37 and the delivery quantity, such as the regular quantity 36a1 and the high-octane quantity 36a2. If delivery companies are different, the delivery costs can be different for the same trip. In such a case, a plurality of delivery blocks 3 with the same trip may be generated. In such a case, the delivery blocks 3 may contain identification information regarding the delivery companies.

Furthermore, the optimization apparatus 100a can also be used to optimize the total distance 37 in addition to optimizing the total delivery efficiency 38 or the total delivery cost, as described later. In such a case, the delivery block 3 may not contain the delivery efficiency 38.

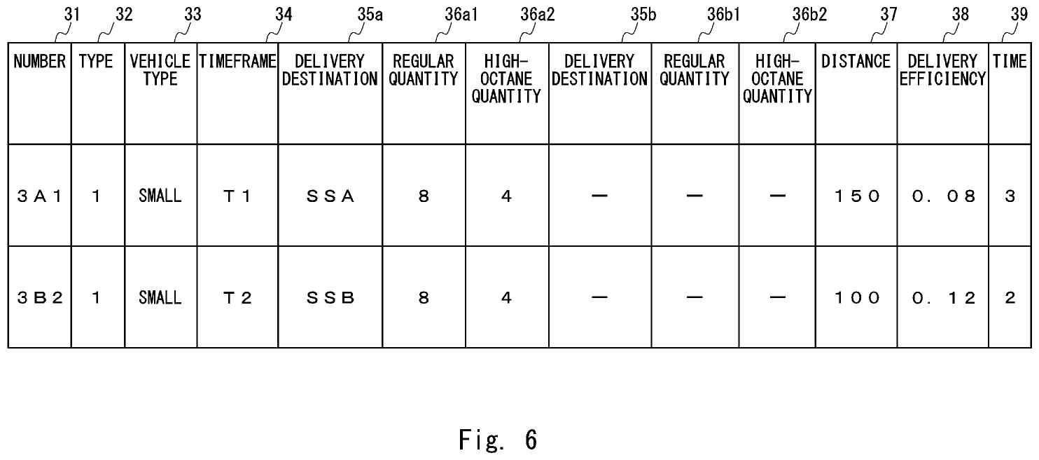

FIG. 6 is a diagram showing an example of a delivery block corresponding to a delivery task for delivery to one consumption location. A delivery block 3A1 corresponds to the delivery information 2A1 shown in FIG. 4. A delivery block 3B2 corresponds to the delivery information 2B2 shown in FIG. 4. In each of the delivery blocks 3A1 and 3B2, the type 32 of the trip is “1”. In each of the delivery blocks 3A1 and 3B2, the vehicle type 33 is small because the total delivery quantity is 12 kl (8 kl+4 kl). In addition, in each of the delivery blocks 3A1 and 3B2, the delivery destination 35b, the regular quantity 36b1, and the high-octane quantity 36b2 are not registered.

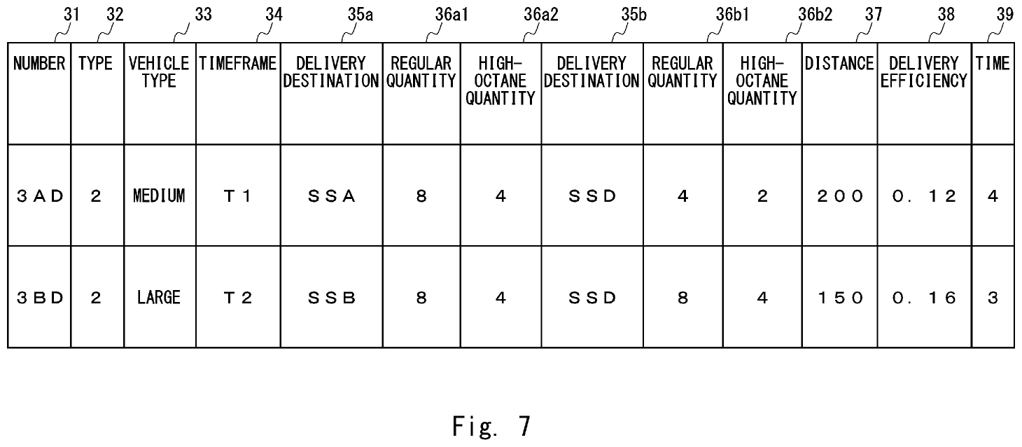

FIG. 7 is a diagram showing an example of a delivery block corresponding to a delivery task for delivery to two consumption locations. A delivery block 3AD corresponds to the delivery task for delivery to SSA and SSD in the timeframe T1 in FIG. 4. Since the delivery block 3AD is generated based on the delivery information 2A1 and 2D1, it can be considered as a concatenation of the delivery information 2A1 and 2D1. In addition, the delivery block 3BD corresponds to the delivery task for delivery to SSB and SSD in the timeframe T2 in FIG. 4. Since the delivery block 3BD is generated based on the delivery information 2B2 and 2D2, it can be considered as a concatenation of the delivery information 2B2 and 2D2.

In each of the delivery blocks 3AD and 3BD, the type 32 of the trip is “2”. In the delivery block 3AD, the total delivery quantity is 18 kl (8+4+4+2), and the vehicle type 33 is medium. In the delivery block 3BD, the total delivery quantity is 24 kl (8+4+8+4), and the vehicle type 33 is large.

Returning to FIG. 3, the optimization apparatus 100a includes the selection unit 140a. The selection unit 140a is an example of the selection unit 140 described above. The selection unit 140a selects (extracts), from the plurality of delivery blocks generated by the determination unit 130a, delivery tasks for actual deliveries. The selection unit 140a includes a formulation unit 141 that formulates the Hamiltonian to be used for optimization, a data creation unit 142 that generates Ising model data from the result of the formulation, an annealing processing unit 143 that performs simulated annealing or quantum annealing, and a result display unit 144. The selection unit 140a calculates the solution that maximizes or minimizes the formulated objective function by annealing.

The formulation unit 141 generates the Hamiltonian to be used for optimization. The Hamiltonian contains, for example, the constraint terms shown in Expressions 1 to 5 below. Note that the Hamiltonian does not need to include all of the constraint terms shown in Expressions 1 to 5. The Hamiltonian also contains any of the objective functions shown in Expressions 6 to 8 below. Therefore, the Hamiltonian can be expressed as in Expression 9, Expression 10, or Expression 11 below. Expressions 1 to 11 are sequentially described below.

[Expression 1]

H1=Σ_{S∈S1}(1−Σ_{b∈b}_{_{S}}x[b])² (1)

Expression 1 is a constraint term expressing a constraint that delivery must be made to each of the first kind of consumption locations SS once, where x[b] is a variable that is 1 when the delivery block b is adopted and 0 otherwise. In addition, S1 represents a set of first kind of consumption locations. Thus, the first sigma sign means to calculate the sum for the first kind of consumption locations. In addition, bs represents the delivery blocks for delivery to a consumption location s, which is the first kind of consumption location. Thus, the second sigma sign means to calculate the sum for the delivery blocks including the targeted consumption location s (the first kind of consumption location).

[Expression 2]

H2=Σ_{S∈S2}{(0.5−Σ_{b∈b}_{_{S}}x[b])²−0.25} (2)

Expression 2 is a constraint term expressing a condition that delivery must be made to each of the second kind of consumption locations SS zero times or once, where S2 represents a set of second kind of consumption locations. Thus, the first sigma sign means to calculate the sum for the second kind of consumption locations. The second sigma sign means to calculate the sum for the delivery blocks including the targeted consumption location s (the second kind of consumption location).

[Expression 3]

H31=Σₗ(Σₙ₌₀^{N}^{ₗ}n*y[l,n]−Σ_{b∈b}_{ₗ}x[b])² (3)

Expression 3 is a constraint term expressing a condition that the number of delivery blocks for each vehicle type must be less than or equal to Nₗ, where “l” (“l” is the lower case of the letter L in the alphabet) is a subscript representing the vehicle type. Thus, the first sigma sign means to calculate the sum for the vehicle type 1. In addition, y[l, n] is a variable that is 1 when n delivery blocks are assigned to the vehicle type 1 and 0 otherwise. Then, Nₗ is the upper limit of the number of vehicles in each vehicle type. Thus, the second sigma sign means to calculate the sum for the number of vehicles n=0 to Nₗ. In addition, b₁ means the delivery blocks in which the vehicle type 1 is set. Thus, the third sigma sign means to calculate the sum for the delivery blocks assigned to the targeted vehicle type 1.

[Expression 4]

H32=Σₗ(1−Σₙ₌₀^{N}^{ₗ}y[l,n])² (4)

Expression 4 expresses a one-hot condition on the number of delivery blocks assigned to the vehicle type 1. This limits the number of delivery blocks for delivery using the vehicle type 1 to any of 0 to Nₗ.

[Expression 5]

H4=Σ_{b}x[b] (5)

Expression 5 expresses a constraint that the number of delivery blocks to be selected is reduced. This reduces the number of vehicles to be used for delivery.

[Expression 6]

Ho1=−Σ_{b}x[b]*vd[b] (6)

Expression 6 indicates an objective function for maximizing the quantity of transportation per travel distance of a vehicle (delivery efficiency), where vd[b] means the delivery efficiency. By containing such an objective function, a delivery block with higher delivery efficiency is more likely to be selected.

[Expression 7]

Ho2=Σ_{b}x[b]*c[b] (7)

Expression 7 indicates an objective function for minimizing the total delivery cost, where c[b] means the delivery cost set for the delivery block. By containing such an objective function, a delivery block with smaller delivery cost is more likely to be selected.

[Expression 8]

Ho3=Σ_{b}x[b]*d[b] (8)

Expression 8 indicates an objective function for minimizing the travel distance of a vehicle, where d[b] means the travel distance set in the delivery block. By containing such an objective function, a delivery block with a smaller travel distance is more likely to be selected.

[Expression 9]

H=W1*H1+W2*H2+W31*H31+W32*H32+W4*H4+Wo1*Ho1 (9)

Expression 9 indicates an example of the Hamiltonian used for annealing, where W1, W2, W31, W32, W4, and Wo1 are numerical values representing weights. Expression 9 is the Hamiltonian for optimizing the delivery efficiency. The objective function of Expression 9 is Ho1 in Expression 6.

[Expression 10]

H=W1*H1+W2*H2+W31*H31+W32*H32+W4*H4+Wo2*Ho2 (10)

Expression 10 is the Hamiltonian for optimizing the delivery cost, where Wo2 is a numerical value representing a weight. The objective function of Expression 10 is Ho2 in Expression 7.

[Expression 11]

H=W1*H1+W2*H2+W31*H31+W32*H32+W4*H4+Wo3*Ho3 (11)

Expression 11 is the Hamiltonian for optimizing the travel distance, where Wo3 is a numerical value representing a weight. The objective function of Expression 11 is Ho3 in Expression 8.

Returning to FIG. 3, the data creation unit 142 creates Ising data to be used for annealing based on the objective function created by the formulation unit 141. The Ising data is the interaction coefficient between each spin or the like. The annealing processing unit 143 performs annealing using the created Ising data. The annealing processing unit 143 may perform simulated annealing using dedicated hardware called an annealing machine or may perform quantum annealing using a quantum computer. This can allow the optimization calculation to be performed in a shorter time. The annealing processing unit 143 may solve the optimization problem using a quantum Monte Carlo method or the like. If annealing is performed outside of the optimization apparatus 100a, the selection unit 140a may not include the annealing processing unit 143.

By performing annealing, the delivery blocks corresponding to the actual delivery tasks are selected from the plurality of delivery blocks registered by the determination unit 130a. This determines the number of vehicles to be used in each timeframe for each vehicle type. In other words, the number of large vehicles, the number of medium vehicles, and the number of small vehicles to be used in the timeframe T1, the number of large vehicles, the number of medium vehicles, and the number of small vehicles to be used in the timeframe T2, and the number of large vehicles, the number of medium vehicles, and the number of small vehicles to be used in the timeframe T3 are determined.

Here, the number of vehicles for each vehicle type corresponds to the number of selected delivery blocks. For example, it is assumed that the timeframe T1 has been set in the delivery blocks 3a, 3b, 3c, 3d, and 3e among the delivery blocks selected by annealing. Here, it is assumed that large vehicle has been set as the vehicle type in the delivery blocks 3a and 3b, that medium vehicle has been set as the vehicle type in the delivery blocks 3c and 3d, and that small vehicle has been set as the vehicle type in the delivery block 3e. In such a case, two large vehicles, two medium vehicles, and one small vehicle are to be used in the timeframe T1.

The result display unit 144 displays the delivery blocks selected by annealing on a display device, such as a display or the like. The operator can check the indication of the display or the like and give delivery instructions to the delivery companies or the like. The result display unit 144 may further display the number of vehicles of each vehicle type to be used in each timeframe on the display.

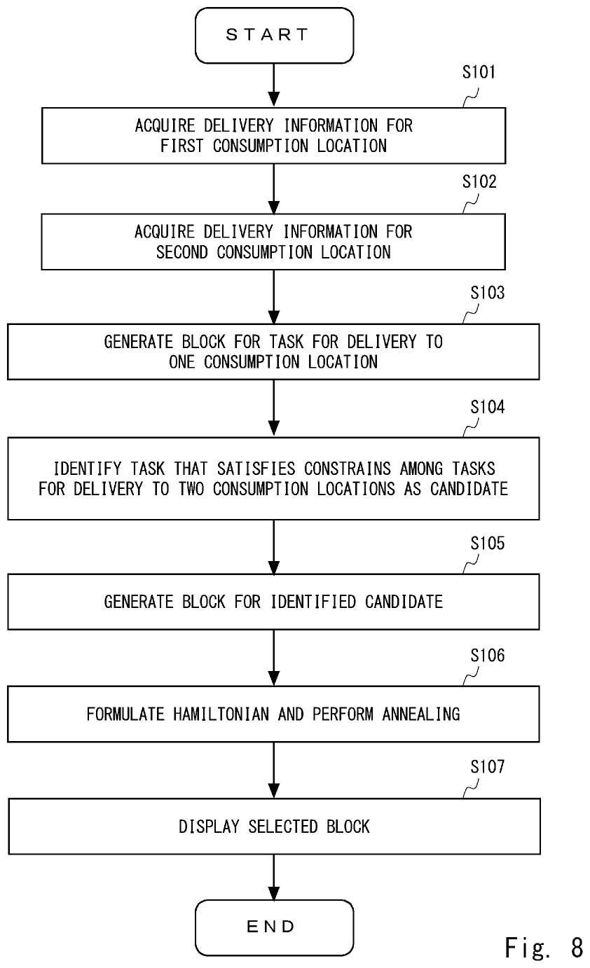

FIG. 8 is a flowchart showing a procedure of an optimization method according to the second example embodiment. The acquisition unit 110a of the optimization apparatus 100a first acquires order information from the data management device 200 and acquires delivery quantity (delivery information) for each first kind of consumption location based on the order information (step S101). Next, the optimization apparatus 100a acquires delivery quantity (delivery information) for each second kind of consumption location for each timeframe (step S102) based on the result of daily gasoline consumption forecast by the consumption forecast device 300 or the like. Note that the order of steps S101 and S102 may be reversed.

Next, the determination unit 130a of the optimization apparatus 100a generates delivery blocks for delivery tasks for delivery to one consumption location from the delivery information acquired in step S101 and the delivery information acquired in step S102 (step S103). The delivery block contains information regarding the vehicle type, delivery efficiency, and the like. The vehicle type may be determined depending on the delivery quantity of the product.

Next, the identification unit 120a of the optimization apparatus 100a identifies delivery task candidates for delivery to two consumption locations (step S104). The identification unit 120a identifies, as delivery task candidates, delivery tasks that satisfies the constraints among delivery tasks for delivery to two consumption locations.

In other words, the identification unit 120a identifies, as candidates for the delivery tasks, delivery tasks for delivery to one consumption location and delivery tasks that satisfies the constraints among delivery tasks for delivery to two consumption locations. Note that the identification unit 120a may also identifies, as candidates, delivery tasks for delivery to three or more consumption locations.

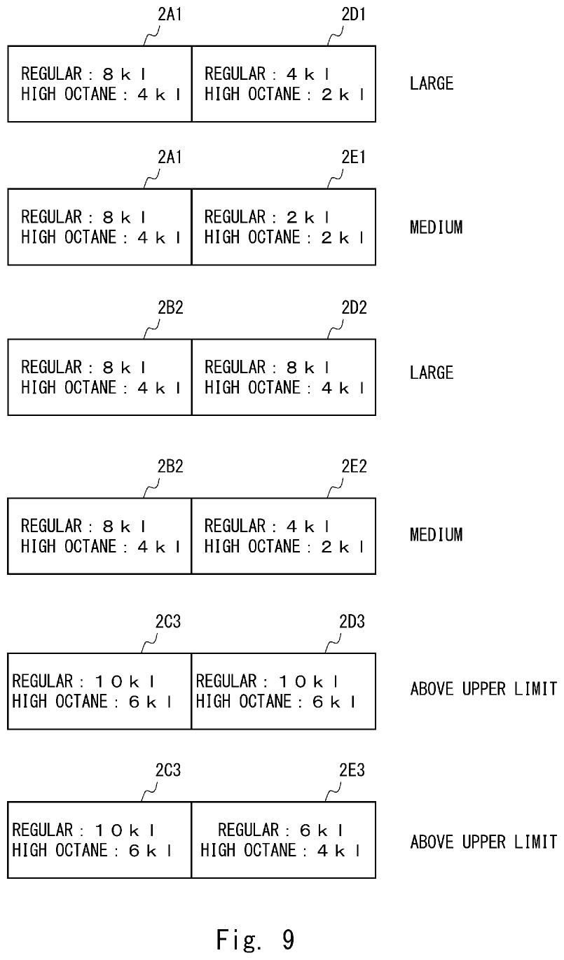

With reference to FIGS. 4 and 9, the identification method in step S104 is specifically described. The identification unit 120a identifies the delivery information 2A1 to 2E3 shown in FIG. 4 that can be combined. Here, it is assumed that the identification unit 120a combines two pieces of delivery information in the same timeframe. In such a case, the six combinations shown in FIG. 9 are possible. Here, the identification unit 120a calculates the total delivery quantity for each combination and determines whether the total delivery quantity exceeds the upper limit (for example, 24 kl). For example, referring to the combination of the delivery information 2C3 and the delivery information 2E3, the total delivery quantity is 26 kl, which is above the upper limit. The identification unit 120a then identifies the combination in which the total delivery quantity is less than or equal to the upper limit as a candidate for the delivery task. In the case of FIG. 9, the identification unit 120a identifies four combinations as candidates. Each candidate can be classified as large, medium, or small based on the total delivery quantity.

Returning to FIG. 8, the determination unit 130a generates delivery blocks for the candidates identified in step S104 (step S105). The delivery blocks may be generated using the delivery block generated in step S103. The determination unit 130a determines the vehicle type, delivery efficiency, and the like similarly to step S103, and generates the delivery blocks according to the determination result.

Next, the selection unit 140a of the optimization apparatus 100a formulates the Hamiltonian, creates Ising data from the Hamiltonian, and performs annealing (step S106). The Hamiltonian contains variables that indicate whether to adopt each candidate, and task candidates can be selected from the calculation results. Since the vehicle type is set to each candidate, selecting a task candidate can be said to be assigning a delivery operation to the vehicle. Finally, the selection unit 140a displays the selected delivery blocks on the display based on the result of annealing (step S107).

The optimization apparatus according to the second example embodiment first identifies a plurality of delivery task candidates by means other than annealing. Then, when selecting tasks for actual deliveries from the plurality of candidates, annealing is performed. Therefore, the optimization apparatus according to the second example embodiment can reduce the time required for annealing. As a result, the optimization apparatus according to the second example embodiment can possibly create a delivery plan in a realistic time even when the number of consumption locations increases.

In the above examples, the various control programs can be stored by various types of non-transitory computer-readable media and provided to a computer. Non-transitory computer-readable media include any type of tangible storage media. Examples of non-transitory computer-readable media include magnetic storage media (such as flexible disks, magnetic tapes, and hard disk drives), optical magnetic storage media (such as magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, and Random Access Memory (RAM)). The programs may be provided to a computer using any type of transitory computer-readable media. Examples of transitory computer-readable media include electric signals, optical signals, and electromagnetic waves. Transitory computer readable media can provide the programs to a computer through a wired communication line (such as electric wires, and optical fibers) or a wireless communication line.

Note that, the present invention is not limited to the above example embodiments and can be modified without departing from the gist thereof.

The present invention has been described above with reference to the example embodiments but is not limited by the above. Various modifications that can be understood by those skilled in the art can be made to the configurations and the details of the present invention within the scope of the invention.

This application is based upon and claims the benefit of priority of Japanese Patent Application No. 2021-002925 filed on Jan. 12, 2021, the disclosure of which is incorporated herein in its entirety by reference.

### REFERENCE SIGNS LIST

100, 100a OPTIMIZATION APPARATUS
110, 110a ACQUISITION UNIT
120, 120a IDENTIFICATION UNIT
130, 130a DETERMINATION UNIT
140, 140a SELECTION UNIT
141 FORMULATION UNIT
142 DATA CREATION UNIT
143 ANNEALING PROCESSING UNIT
144 RESULT DISPLAY UNIT
200 DATA MANAGEMENT DEVICE
300 CONSUMPTION FORECAST DEVICE
2A1, 2B2, 2C3, 2D1, 2D2, 2D3, 2E1, 2E2, 2E3 DELIVERY INFORMATION
3, 3A1, 3B2, 3AD, 3BD DELIVERY BLOCK
31 NUMBER
32 TYPE
33 VEHICLE TYPE
34 TIMEFRAME
35a, 35b DELIVERY DESTINATION
36a1, 36b1 REGULAR QUANTITy
36a2, 36b2 HIGH-OCTANE QUANTITy
37 DISTANCE
38 DELIVERY EFFICIENCY
39 TIME
1001 PROCESSOR
1002 MEMORY
1003 STORAGE DEVICE

What is claimed is:

1. An optimization apparatus comprising:
at least one memory storing instructions and
at least one processor configured to execute the instructions to;
acquire delivery information regarding each of one or more products for each of a plurality of consumption locations;
identify a plurality of delivery task candidates departing from a delivery source, delivering the one or more products to each of one or more consumption locations, and returning to the delivery source;
determine, based on the delivery information, at least one of evaluation values and a vehicle type of a delivery vehicle for each candidate; and
select a plurality of delivery tasks from the plurality of identified candidates based on a result of optimizing an objective function based on a determination result.

2. The optimization apparatus according to claim 1, wherein the at least one processor is further configured to execute the instructions to:
select the plurality of delivery tasks from the plurality of candidates based on the result of optimizing the objective function by annealing.

3. The optimization apparatus according to claim 1, wherein the at least one processor is further configured to execute the instructions to:
identify, as first kind of candidates, delivery tasks for delivery to one consumption location and, as second kind of candidates, delivery tasks for delivery to a plurality of consumption locations where mutual distances are less than or equal to a threshold.

4. The optimization apparatus according to claim 3, wherein the at least one processor is further configured to execute the instructions to:
determine whether a delivery quantity of the one or more products in a delivery task is less than or equal to a threshold when identifying the second kind of candidate, and identify the delivery task as the second kind of candidate when a determination result is true.

5. The optimization apparatus according to claim 1, wherein the at least one processor is further configured to execute the instructions to:
determine the vehicle type of the delivery vehicle in each candidate based on the delivery information, and
optimize the objective function with satisfying a constraint on the number of vehicles of each vehicle type.

6. The optimization apparatus according to claim 1, wherein the at least one processor is further configured to execute the instructions to:
determine quantity of transportation per travel distance, a delivery cost, or a travel distance in each candidate as the evaluation value, and
optimize the objective function including the evaluation value.

7. The optimization apparatus according to claim 1, wherein
the one or more consumption locations include first kind of consumption location where a timeframe for delivery is specified and second kind of consumption location where a timeframe for delivery is not specified, and the at least one processor is further configured to execute the instructions to:
acquire the timeframe for delivery and delivery quantity of each of the one or more products for the first kind of consumption location and acquire, for each timeframe, delivery quantity of each of the one or more products when delivery is to be made for the second kind of consumption location, and
optimize the objective function with satisfying constraints that the number of times of delivery to the first kind of consumption location is one and that the number of times of delivery to the second kind of consumption location is zero or one.

8. The optimization apparatus according to claim 1, wherein the at least one processor is further configured to execute the instructions to:
generate, for each of the plurality of candidates, delivery data including delivery destinations, delivery quantity of each of the one or more products for each delivery destination, the vehicle type, and the evaluation values, and register the delivery data in a storage device, and
display the delivery data for each selected delivery task on a display device.

9. An optimization method comprising:
acquiring, by a computer, delivery information regarding each of one or more products for each of a plurality of consumption locations;
identifying, by the computer, a plurality of delivery task candidates departing from a delivery source, delivering the one or more products to each of one or more consumption locations, and returning to the delivery source;
determining, by the computer, at least one of evaluation values and a vehicle type of a delivery vehicle for each candidate based on the delivery information; and
selecting, by the computer, a plurality of delivery tasks from the plurality of identified candidates based on a result of optimizing an objective function based on a determination result.

10. A non-transitory computer-readable medium containing an optimization program causing a computer to execute:
acquiring delivery information regarding each of one or more products for each of a plurality of consumption locations;
identifying a plurality of delivery task candidates departing from a delivery source, delivering the one or more products to each of one or more consumption locations, and returning to the delivery source;
determining at least one of evaluation values and a vehicle type of a delivery vehicle for each candidate based on the delivery information; and
selecting a plurality of delivery tasks from the plurality of identified candidates based on a result of optimizing an objective function based on a determination result.
